(19) United States
(12) Patent Application Publication
(10) Pub. No.: US 2009/0175703 A1
(43) Pub. Date: Jul. 9, 2009

(54) SCREW RETAINING STRIP

(76) Inventor: Shih-Jhong Huang, Ping dong (TW)

Correspondence Address: Shih-Jhong Huang, 235 Chung-Ho, Box 8-24, Taipei, TW

(21) Appl. No.: 11/970,514

(22) Filed: Jan. 7, 2008

(51) Int. Cl. F16B 27/00; F16B 15/08; B65D 85/24

(52) U.S. Cl. 411/442; 206/345

(57) ABSTRACT

A screw retaining strip comprising: a strip body made of plastics; a plurality of screws being vertically arranged on the strip body as a bank; the strip body being a slender strip and being bent upwards so that the strip body can provide sufficient stress to support the weight of the screws, wherein when screw retaining strip is combined with a nail driver and to shoot the screws forwards, it will avoid the screw retaining strip to bend downwards; and thus the distal end of the screw will not contact a surface of a work piece or is buckled to a corner of the work piece so as to prevent the distal end of the screw to scratch a surface of the work piece or the screw retaining strip can not smoothly enter into the nail driver.

### FIELD OF THE INVENTION

The present invention relates to retaining of screws, and particularly to a screw retaining strip which can improve the defect in the prior art. By the present invention, the distal end of the screw will not contact a surface of a work piece or is buckled to a corner of the work piece so as to prevent the distal end of the screw to scratch a surface of the work piece or the screw retaining strip can not smoothly enter into the nail driver.

### BACKGROUND OF THE INVENTION

Referring to FIGS. 1 and 2, the prior art screw retaining strip 10 has a screw retaining strip 11 and a plurality of screws 42 which are arranged as a bank and are vertical arranged on the screw retaining strip 11. The prior art screw retaining strip 10 can be used with a nail driver 20 so as to achieve the object of the shooting a nail.

However the prior art strip body 11 is made of plastics and is a long narrow strip which has no sufficient stress to support the weights of the nails 12. When the prior art screw retaining strip 10 is combined with the nail driver 20, the whole screw retaining strip 10 will bend downwards, especially when the nail driver 20 shoots a nail as it faces downwards (referring to FIG. 2). The distal end of the screw 12 at the end of the strip body 11 will eject against a surface of a work piece 30 or is buckled to a corner of the work piece 30 so that the distal end of the screw 12 will scratch the surface of the work piece 30, or cause that the strip body can not be supplied to the nail driver 30 smoothly.

### SUMMARY OF THE INVENTION

Accordingly, the object of the present invention is to provide a screw retaining strip which can improve the defect in the prior art. By the present invention, the distal end of the screw will not contact a surface of a work piece or is buckled to a corner of the work piece so as to prevent the distal end of the screw to scratch a surface of the work piece or the screw retaining strip can not smoothly enter into the nail driver.

To achieve above object, the present invention provides a screw retaining strip comprising: a strip body made of plastics; a plurality of screws being vertically arranged on the strip body as a bank; the strip body being a slender strip and being bent upwards so that the strip body can provide sufficient stress to support the weight of the screws, wherein when screw retaining strip is combined with a nail driver and to shoot the screws forwards, it will avoid the screw retaining strip to bend downwards; and thus the distal end of the screw will not contact a surface of a work piece or is buckled to a corner of the work piece so as to prevent the distal end of the screw to scratch a surface of the work piece or the screw retaining strip can not smoothly enter into the nail driver.

The various objects and advantages of the present invention will be more readily understood from the following detailed description when read in conjunction with the appended drawing.

### BRIEF DESCRIPTION OF THE DRAWINGS

FIG. 1 is a plane structure of a plurality of screw retaining strip.

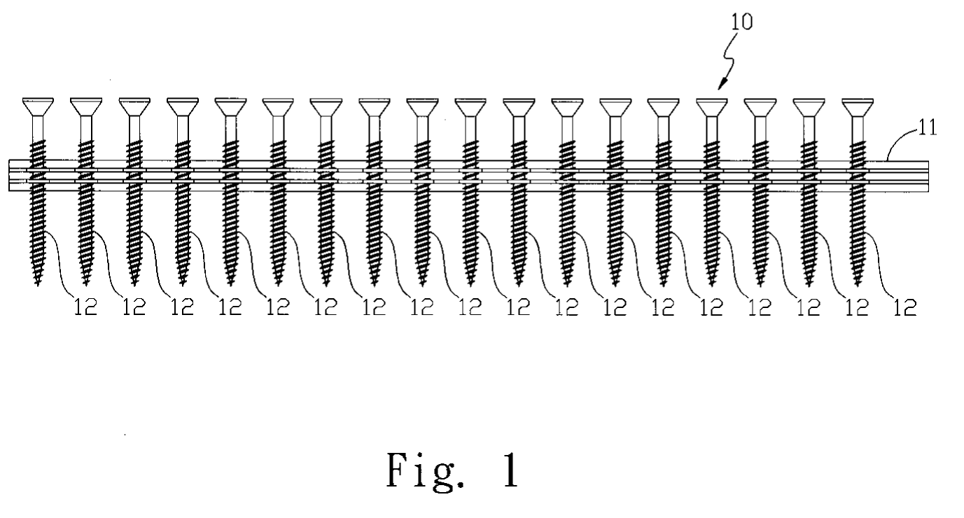

FIG. 2 is a schematic view showing the use of the prior art screw retaining strip.

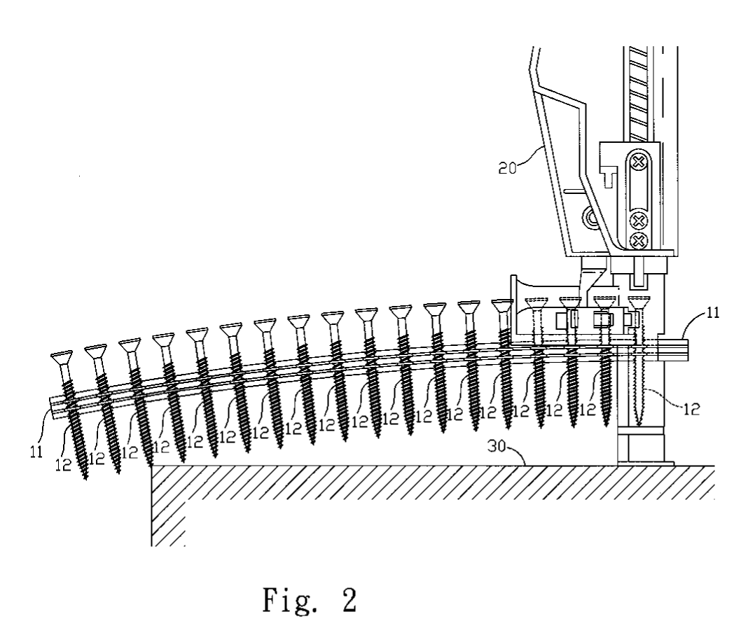

FIG. 3 is a plane view of the present invention.

FIG. 4 is a schematic view showing the use of the present invention.

### DETAILED DESCRIPTION OF THE INVENTION

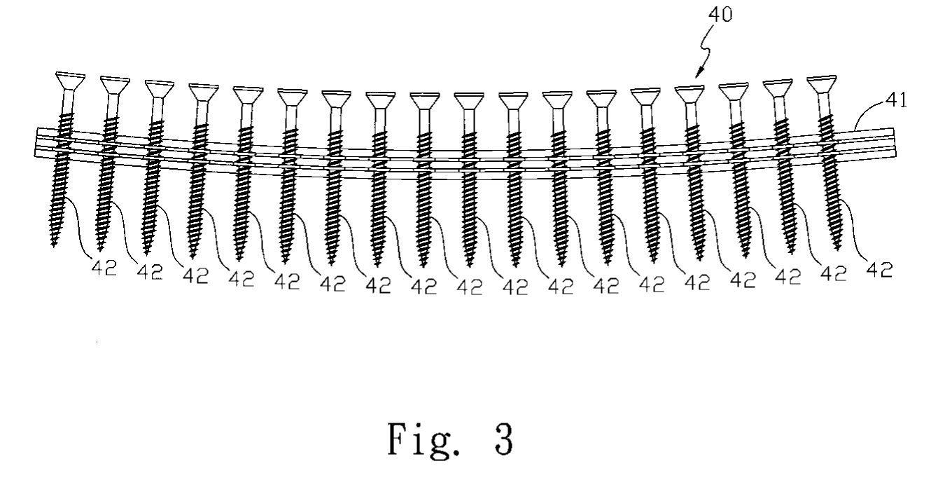

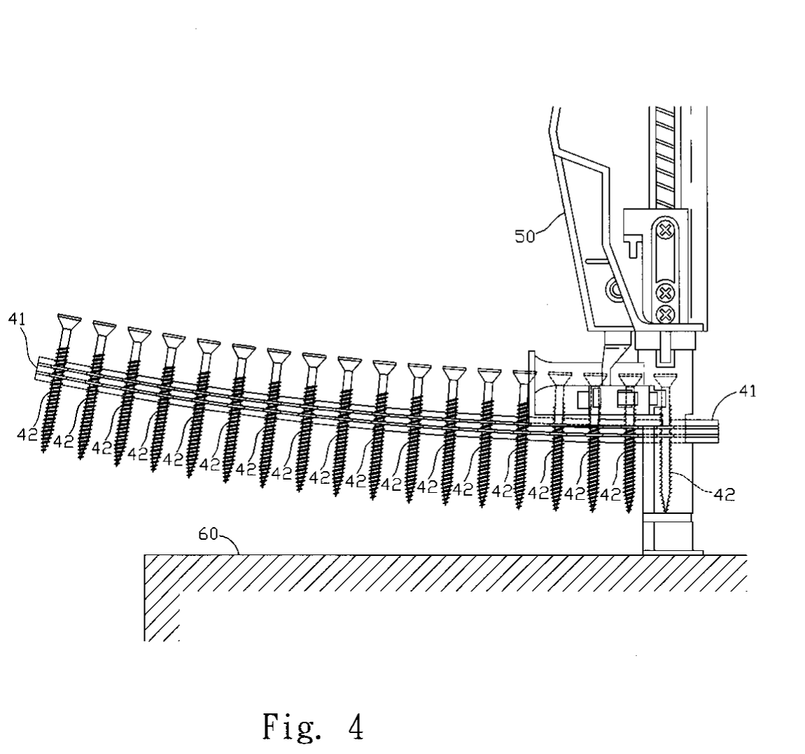

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. With referring to FIGS. 3 and 4, the structure of the screw retaining strip 40 of the present invention will be described herein.

A strip body 41 is made of plastics. A plurality of screws 42 are vertically arranged on the strip body 41 as a bank. The strip body 41 is a slender strip and is bent upwards so that the strip body 41 can provide sufficient stress to support the weight of the screws 42. When screw retaining strip 40 of the present invention is combined with a nail driver 50 and to shoot the screws forwards (referring to FIG. 4), it will avoid the screw retaining strip 40 to bend downwards. Thus the distal end of the screw 42 will not contact a surface of a work piece 60 or is buckled to a corner of the work piece 60 so as to prevent the distal end of the screw 42 to scratch a surface of the work piece 60 or the screw retaining strip can not smoothly enter into the nail driver 50.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw retaining strip comprising: a strip body made of plastics; a plurality of screws being vertically arranged on the strip body as a bank; the strip body being a slender strip and being bent upwards so that the strip body can provide sufficient stress to support the weight of the screws, wherein when screw retaining strip is combined with a nail driver and to shoot the screws forwards, it will avoid the screw retaining strip to bend downwards; and thus the distal end of the screw will not contact a surface of a work piece or is buckled to a corner of the work piece so as to prevent the distal end of the screw to scratch a surface of the work piece or the screw retaining strip can not smoothly enter into the nail driver.
